(19) United States
(12) Patent Application Publication
(10) Pub. No.: US 2012/0090068 A1
(43) Pub. Date: Apr. 19, 2012

(54) USER-MOLDABLE SPORTS EQUIPMENT USING HEATED WATER BATH

(75) Inventors: Doug Glass, Lacey, WA (US); Julie Glass, Lacey, WA (US); Luigino Verducci, Porto Sant' Elpidio (IT)

(73) Assignee: NISTEVO SPORT MANUFACTURING CORPORATION, Lacey, WA (US)

(21) Appl. No.: 13/235,287

(22) Filed: Sep. 16, 2011

Related U.S. Application Data
(60) Provisional application No. 61/383,591, filed on Sep. 16, 2010.

(51) Int. Cl. A41D 13/06; B32B 1/00; A43B 5/00; B29C 53/36; B29C 65/56

(52) U.S. Cl. 2/22; 156/196; 156/91; 36/114; 428/174

(57) ABSTRACT

A method and apparatus is disclosed for user-moldable sports equipment, for example, shin guards and sports shoes. The sports equipment includes an integral component having relatively rigid thin shell curved walls with a thermoplastic component sandwiched in between the thin shells. The thermoplastic transitions to a moldable state at a temperature between 150° F. and 210° F. The sports equipment is placed in a waterproof bag and into heated water to become moldable, and hardens to a rigid state when cooled. In a heel cup embodiment, a composite layer is applied directly to the shoe upper, and a pre-formed thermoplastic component is positioned over the composite layer. A second composite layer is then laid over the thermoplastic component and the assembly is cured. The heel cup may include arms that extend upwardly to engage the shoe closure structure.

### CROSS-REFERENCE TO RELATED APPLICATION

This application claims the benefit of Provisional Application No. 61/383,591, filed Sep. 16, 2010, the entire disclosure of which is hereby incorporated by reference herein.

### BACKGROUND

The present invention relates to user-moldable sports equipment, the method for constructing user-moldable sports equipment, and the method for customizing user-moldable sports equipment.

The growth of the sports and fitness industry in the U.S. and throughout the world has been astronomical over the past decade largely due to the interest of a greater segment of the population in these activities.

In the marketplace, commercial sports equipment is generally available for purchase in fixed standardized sizes. Those who fall outside of the standard sizes or prefer a better fit must opt for custom-manufactured sports equipment. However, custom-manufactured sports equipment can be cost prohibitive, especially for the recreational user, and is also impractical for children who will likely outgrow the custom equipment in a short time.

User-moldable sports equipment offers the benefits of custom-manufactured sports equipment without the associated costs. Moreover, the user-moldable sports equipment allows the user to repeatedly custom fit the equipment to achieve the desired fit.

A number of approaches have been developed to provide customized articles. In one approach, the article includes a layer of thermoplastic material which will soften when heated. The wearer then presses a body part against the heated article, creating an impression. The excess thermoplastic material is released and discarded. The remaining thermoplastic material is then allowed to cool while retaining the impression of the wearer's body part. An example of this approach is disclosed in U.S. Pat. No. 5,733,647, which is hereby incorporated by reference in its entirety. In this example, the thermoplastic material comprises a mixture of ethylene copolymers with an ethylene terpolymer such as ethylene vinyl acetate modified by the addition of carbonyl groups incorporated as part of the main chain.

Custom moldable products that rely on a thermoplastic component that is conformable when heated and rigid at lower temperatures have additional drawbacks. It can be very problematic to heat the product into a moldable state. Typically, the product is placed in a convective heater, such as an oven, or into an active heating device, such as a microwave oven. For example, it is difficult to achieve a desired temperature without overheating (and potentially damaging the product) or underheating (such that the desired conformability is not produced). In particular, achieving a desired temperature throughout the conformable thermoplastic material can be problematic. If heating is not consistent throughout the material, the product may harden irregularly to produce undesirable shapes. Alternatively, or additionally, local hot spots may result that can hurt or injure a user attempting to custom fit the product.

Thus, the need exists for reasonably priced, user-moldable sports equipment which can be custom molded in a safe, simple, and efficient manner.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Component assemblies and methods of construction are disclosed for user-moldable sports equipment. The method includes preforming a thermoplastic center member to a desired shape, wherein the center member is semirigid at temperatures below about 110° F. and transitions to a moldable state at a temperature between about 150° F. and 210° F. A first shell layer is formed, for example, a carbon reinforced polymer, and the pre-formed thermoplastic layer is placed over it. A second shell layer is then placed over the center member, and the assembly is cured such that the first and second shell layers comprise curved thin shell structural components.

In exemplary embodiments the shell layers enclose the thermoplastic center member, which may be formed from a copolymer mixture with ethylene vinyl acetate.

The method may be used for constructing shin guards, sports shoes with integral heel cups with the heel cup permanently fixed to the upper, or the like. In a sports shoe embodiment, the heel cup assembly is formed directly on the upper portion of the shoe. In a particular assembly, the heel cup includes arms that extend upwardly to engage a fastener structure on the sports shoe.

A user-moldable conformable sports product includes a top thin shell structural component comprising a curved thin substantially rigid structure having an initial shape that approximates a desired end shape, a thermoplastic center layer formed from a material having a moldable transition temperature between 150° F. and 210° F., and a bottom thin shell structural component comprising a curved thin shell formed from a curved thin substantially rigid structure having an initial shape that approximates the desired end shape. The sports product is configured such that when heated above the moldable transition temperature the sports component is conformable to the desired end shape and will rigidly retain the desired end shape when cooled to a temperature below the moldable transition temperature.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a shin guard assembly in accordance with the present invention;

FIG. 2 is an exploded view of a shin guard assembly shown in FIG. 1;

FIG. 3 is a cross-sectional view of a portion of the shin guard assembly shown in FIG. 1;

FIG. 4A illustrates the method for heating the user-moldable shin guard in a water bath and FIG. 4B illustrates the method for customizing the user-moldable shin guard;

FIG. 5 illustrates a side view of a sports shoe having a user-moldable heel cup in accordance with the present invention;

FIG. 6A is a perspective view of the user-moldable heel cup of FIG. 5, shown in isolation;

FIG. 6B is a sectional view of the heel cup shown in FIG. 6A taken through section 6B-6B; and

FIG. 7 illustrates a side view of a sports shoe showing an alternative user-moldable heel cup in accordance with the present invention.

### DETAILED DESCRIPTION

The present invention relates to user-moldable sports equipment, the method for constructing user-moldable sports equipment, and the method for customizing user-moldable sports equipment.

Typically commercial sports equipment is generally available for purchase in fixed standardized sizes. Those who fall outside of the standard sizes or prefer a better fit must opt for custom-manufactured sports equipment. However, custom-manufactured sports equipment can be cost prohibitive, especially for the recreational user, and is also impractical for children who will likely outgrow the custom equipment in a short time. Moldable inserts, such as insertable insoles are known; but as separate components, such insertable insoles lack a desirable close integration with the shoe.

User-moldable sports equipment offers the benefits of custom-manufactured sports equipment without the associated costs. The user-moldable sports equipment allows the user to repeatedly custom fit the equipment to achieve the desired fit.

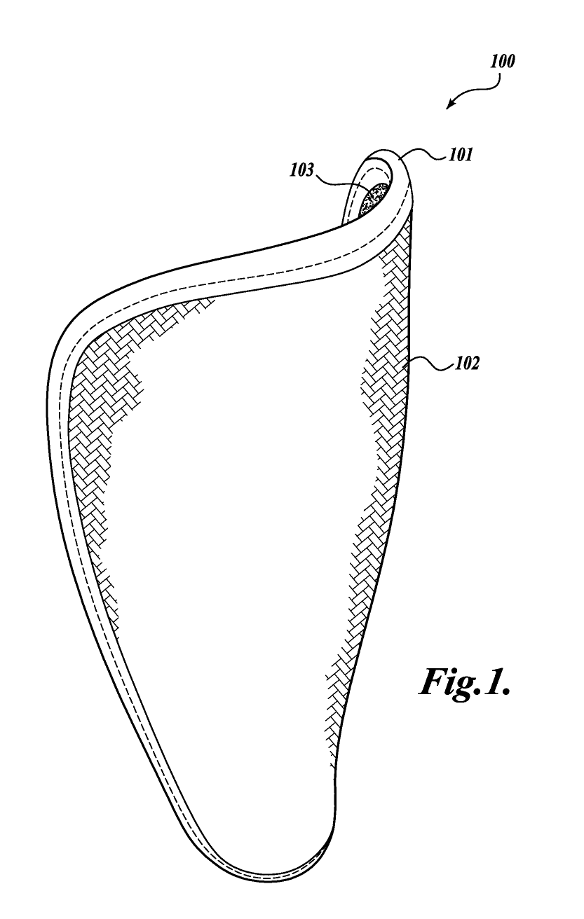

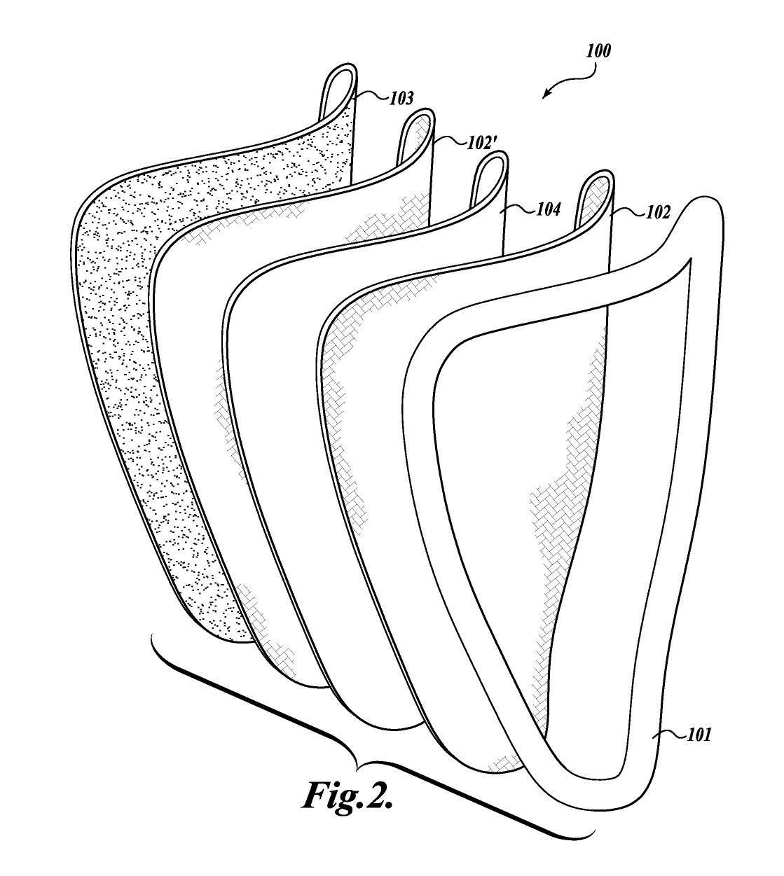

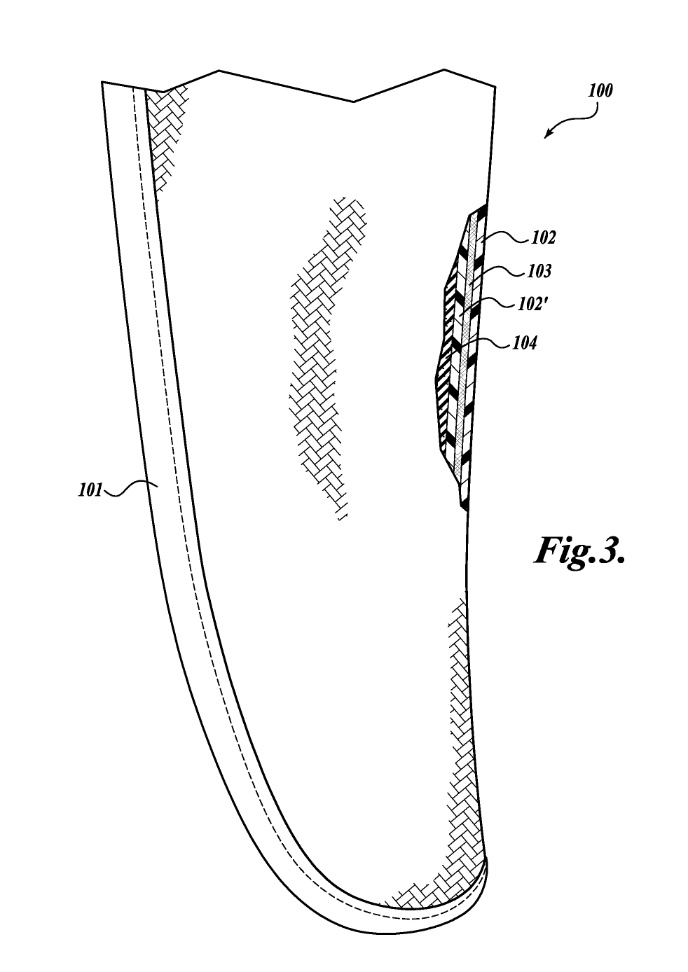

One embodiment of the user-moldable sports equipment in accordance with the present invention is a user-moldable shin guard 100 such as that shown in FIG. 1. Refer also to FIG. 2, which shows an exploded view of the shin guard 100, and to FIG. 3, which shows a partially cross-sectional view of the shin guard 100.

The user-moldable shin guard 100 includes a top layer or shell 102 formed from a relatively stiff composite material such as a carbon-fiber-reinforced polymer, fiberglass, Kevlar, or other suitable material. Although a composite material is currently preferred, it is contemplated that the top shell 102 may alternatively be formed from other rigid materials such as a hard plastic. The top shell 102 is formed to a shape that approximates the contour of a user's shin, for example, with a generally U-shaped curvature that may be constant along its length, or a curvature that is greater near one end and lesser near the opposite end, for example. It should be appreciated that although the shell 102 is formed of a stiff material, it is relatively thin and shaped such that the shell 102 by itself has some flexibility.

A moldable center layer 104 (FIG. 2) sized and shaped to approximately match the top shell 102 is formed from a material having a transition temperature for molding that is between about 150° F. and about 210° F. The center layer 104 is disposed on an underside of the top shell 102 and may be affixed or attached thereto.

A second shell 102′, preferably formed of the same relatively rigid material as the top shell 102, is fixed to the moldable center layer 104 opposite the top shell, thereby encasing the moldable center layer 104 between the top shell 102 and the second shell 102′.

It will be appreciated that the top shell 102 and the second shell 102′ are relatively rigid, two-dimensional curved components that will behave structurally as thin shells. In the structural analysis of plates and shells, a thin shell is defined as a shell with a thickness that is small compared to its other dimensions. Moreover, typically the design deformations are not large compared to thickness. The main difference between a shell structure and a plate structure is that the shell structure has curvature as opposed to plate structures which are flat (when unstressed). It will be appreciated by persons of skill in that art that structurally thin shells behave differently from plates. Where a flat plate acts similarly to a beam with bending and shear stresses, shells are analogous to a cable which resists loads through tensile stresses, though the ideal thin shell is capable of developing both tension and compression.

An inner layer 103 formed from soft material and sized to approximately match the second shell 102′ is then placed over the second shell 102′. The inner layer 103 is intended to be positioned adjacent the user's skin, and is therefore formed from a soft and pliable material for comfort. For example, the inner layer 103 may be formed from a sheet of ethylene vinyl acetate or from another supple man-made or natural material.

An optional edging piece 101 is wrapped around the perimeter of the top shell 102 and inner layer 103. The edging piece 101 defines the perimeter of the shin guard 100 and protects the user from the edges, especially from the edge of the stiff top shell 102. It also helps maintain the integrity of the shin guard 100. The edging piece 101 may be attached thereto, for example, by stitching or gluing. In a current embodiment, the edging piece 101 comprises a flexible fabric having a plastic outer layer.

In a current embodiment, the moldable center layer 104 is a thermoplastic, or a thermosoftening plastic, that becomes moldable when heated to a desired temperature (for example, temperatures between about 150° F. and about 210° F.), but it retains its shape at room temperatures. For example, the center layer 104 may comprise an amorphous, high-molecular-weight polymer whose chains associate through weak Van der Waals forces, stronger dipole-dipole interactions and hydrogen bonding, or stacking of aromatic rings. As another example, the thermoplastic may comprise a copolymer, such as ethylene vinyl acetate or a mixture that includes ethylene vinyl acetate.

A particular advantage of the current embodiment of the shin guard 100 (or other user-moldable sports equipment) is that the center layer 104 is remoldable so that the shin guard 100 (or other user-moldable sports equipment) may be refitted by the user multiple times. For example, a particular user may want to re-fit the user-moldable equipment due to changes in the user's body (e.g., as a young user grows older) or the equipment may be used by a second user who can first mold the equipment as discussed herein.

It will also be appreciated that the typical thermoplastic is insensitive to most common environmental conditions such as moisture in the air, and no special packaging or other storage conditions are required to keep the shin guard 100 viable for molding to the user.

In one method of fabrication, the user-moldable shin guard 100 is assembled with the top shell 102 and the second shell 102′ fabricated to the desired form using conventional techniques, for example, by vacuum molding or compression molding the composite material to a suitably shaped mold. The center thermoplastic layer 104 is pre-shaped and cut to the desired size, and placed over and optionally affixed to the top shell 102. The second shell 102′ is fixed over the center layer 104 such that the center layer 104 is disposed between the two shells 102, 102′. The soft inner layer 103 is placed over and affixed to the second shell 102′, and any excess materials are trimmed from the perimeter of the assembly. The edging 101 is then attached to the perimeter of the top shell 102 and inner layer 103, for example, by sewing or gluing.

In a second method fabrication, the center thermoplastic layer 104 is first formed to the desired shape, for example, using a last or mold. A first layer of composite material for the second shell 102′ is placed over the mold and the resin or epoxy is applied (or the layer is pre-preg). The pre-molded center layer 104 is then placed over the first layer, and a second layer of composite material for the top shell 102 is placed over the opposite side of the pre-molded thermoplastic center layer 104, and an epoxy is applied, if necessary. The assembly is then cured by conventional means, for example, by vacuum molding. After cooling and trimming, the soft inner layer 103 and the perimeter edging 101 are attached.

It will be appreciated that the double thin shell construction of the shin guard 100 will be extremely rigid and lightweight. In particular, the individual shell layers 102, 102′ may be made quite thin because of the double thin shell construction. The thinner construction will permit the relatively rigid shell layers 102, 102′ to exhibit more flexibility than a corresponding thicker shell would provide when the center layer is heated to a moldable state. In one embodiment the pre-molded thermoplastic center layer 104 may be formed smaller than the shell layers 102, 102′ such that the shell layers 102, 102′ bond along the edges and completely encapsulate the center layer 104.

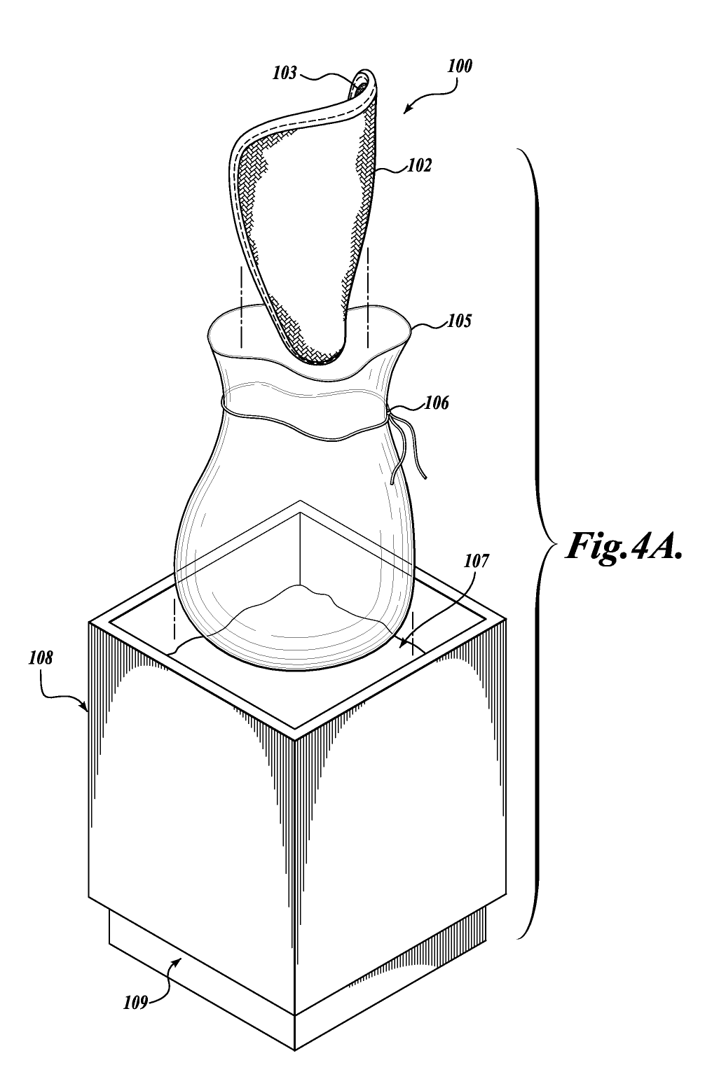

To describe use of the shin guard 100, refer now also to FIGS. 4A and 4B. To customize user-moldable sports equipment such as the shin guard 100, the user places the shin guard 100 in a waterproof bag 105 that is heat resistant at least to about 210° F. The bag 105 in this embodiment is closed by a cinching mechanism 106 to ensure that the shin guard 100 remains dry and in the bag 105. The user then places the bag 105 and shin guard 100 into a container 108 of heated water 107. For example, the container may be disposed over a heat source 109, filled with water 107, and heated to a soft boil, e.g., no higher than about 200° F. The bag 105 and shin guard 100 remain in the hot water 107 for a desired period of time to achieve a consistent temperature through the thermoplastic center layer 104. In a current embodiment, the shin guard 100 remains in the water 107 for about 7-10 minutes. After this time, the bag 105 is removed from the container 108, the cinching mechanism 106 is opened, and the shin guard 100 is removed from the bag 105.

The shin guard 100 is then placed against the user's shin 110 with the inner layer 103 directly proximate to the user's shin 110. The user may then place a fitted sock, elastic wrap, or the like around the shin guard 100 and the user's shin 110, then allow the shin guard 100 to cool. For example, the user may allow cooling for fifteen minutes. After cooling, the user removes the sock, elastic wrap, or other shaping mechanism 111, and the shin guard 100 from the user's leg 110 and allows the shin guard 100 to fully cool. The cooling may be sped up by placing the shin guard 100 in a freezer or other cooler area.

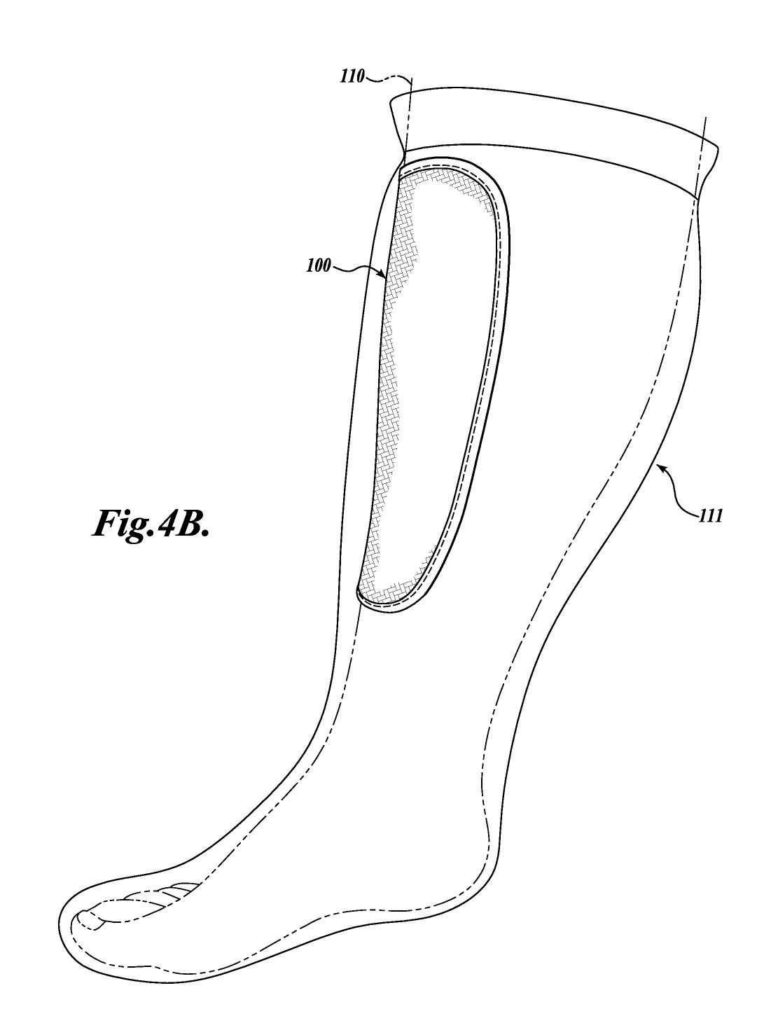

Refer now to FIG. 5, illustrating a side view of an article of sports footwear, for example, a sports boot or shoe 200. The sports shoe 200 may be, for example, a running shoe, football shoe, track shoe, golf shoe, skating shoe, or the like. The shoe includes a flexible and compliant upper 202 that is sized and shaped to generally enclose a user's foot. A relatively stiff sole 204 is fixed to the upper 202, for example, by stitching, adhesives, co-molding, or the like. A fastening mechanism 206 is provided for securing the shoe 200 to the user, and may comprise any conventional fastening mechanism known in the art, for example a lace, cord, strap system, hook and loop fasteners, or the like. The upper 202, sole 204, and fastening mechanism 206 are shown in phantom in order to focus on a novel heel cup 210 of the present invention.

The heel cup 210 in this embodiment is permanently fixed to the upper 202 and to the sole 204. In the current embodiment, the heel cup 210 is fixed to an external surface of the sole 204, although it is contemplated that the heel cup may alternatively be internally integrated into the upper 202. As discussed below, the heel cup 210 is a tough and substantially rigid component, but is also user-moldable such that the heel cup 210 can be customized to the particular user. As shown in FIG. 5, the heel cup 210 may optionally be formed to include one or more cleats 208, or alternatively may be shaped to fit round or otherwise accommodate the cleats 208.

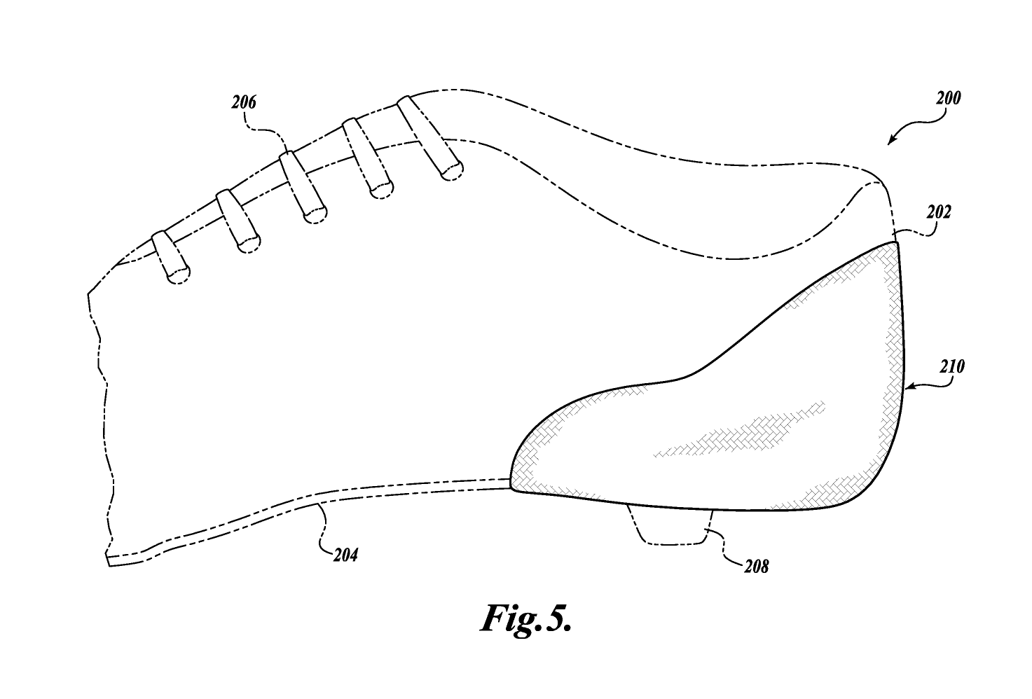

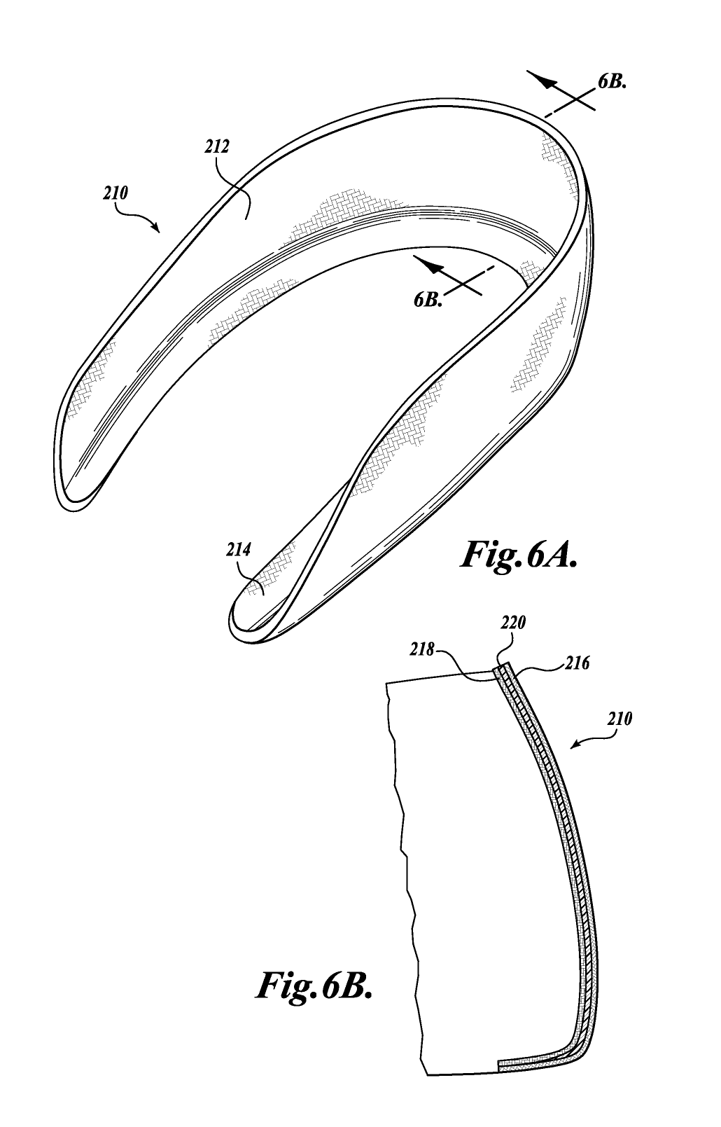

FIG. 6A shows a perspective view of the heel cup 210 in isolation. The heel cup 210 defines a generally U-shaped wall portion 212 that is shaped to wrap around the heel and ankle portion of the upper 202. In this embodiment, the heel cup 210 includes an inwardly oriented flange or rim portion 214 that extends under the upper 202, and may be disposed, in part, between the upper 202 and the sole 204, or may attach to a bottom surface of the sole 204, and form a portion of the sole 204. It is contemplated, however, that the heel cup 210 may alternatively be shaped to include a full floor portion of the heel cup underlying the heel portion of the sole 204. It is also contemplated that the heel cup may not include a rim portion 214 at all, such that the heel cup extends around the back of the foot and ankle, and abuts the sole 204.

FIG. 6B shows a fragmentary cross section of the heel cup 210 through section 6B-6B. The heel cup 210 includes an outer thin shell 216 portion made from a substantially rigid material, such as a carbon-fiber-reinforced polymer. The heel cup 210 also includes an inner thin shell 218 also formed from a substantially rigid material, preferably a carbon-fiber-reinforced polymer. Sandwiched between the outer shell 216 and the inner shell 218 is a thermo softening or thermoplastic center layer 220, similar to the center layer 104 described above.

The material for the thermoplastic layer 220 is selected to be semirigid at typical room or environmental temperatures, e.g., at temperatures below about 110° F., but to soften and become moldable at transition temperatures in the range between about 150° F. and about 210° F. Preferably, the thermoplastic material is also selected to be able to transition between the semirigid and moldable states multiple times.

In a preferred method of construction, the center layer 220 is formed to a desired shape for the heel cup 210. The soft portions of the sports shoe 200 upper 202 are formed on a last (not shown). A layer of composite material for the inner shell 218 is then placed directly onto the upper 202 at the desired heel position and, if necessary, a resin is applied. The pre-formed center layer 220 is then positioned over the inner shell 218 layer, and a composite material for the outer shell 216 is placed over the center layer 220. The assembly is then compression and/or vacuum cured to form the heel cup 210 directly and permanently onto the upper 202.

The end-user of the sports shoe 200 may then mold the sports shoe 200 for a custom fit in a manner similar to that described above, with reference to the shin guard. To customize the sports shoe 200, the user places the entire shoe 200 in a waterproof bag and closes the bag, for example, with a cinching mechanism. The bag and shoe 200 are placed into a container of heated water and remains in the hot water for a desired period of time to achieve a consistent temperature through the center layer 220. The bag and shoe 200 are removed from the water, and the shoe 200 is removed from the bag.

The user then puts on the shoe directly while the shoe is still warm, and presses against the heel cup 210 to shape the shoe to the user's heel and tendon area. For example, the user may hold and mold the heel cup 210 until it cools to a very rigid shape, conforming the shoe 200 to the user. The user may then take off the shoe 200 and allow it to fully cool.

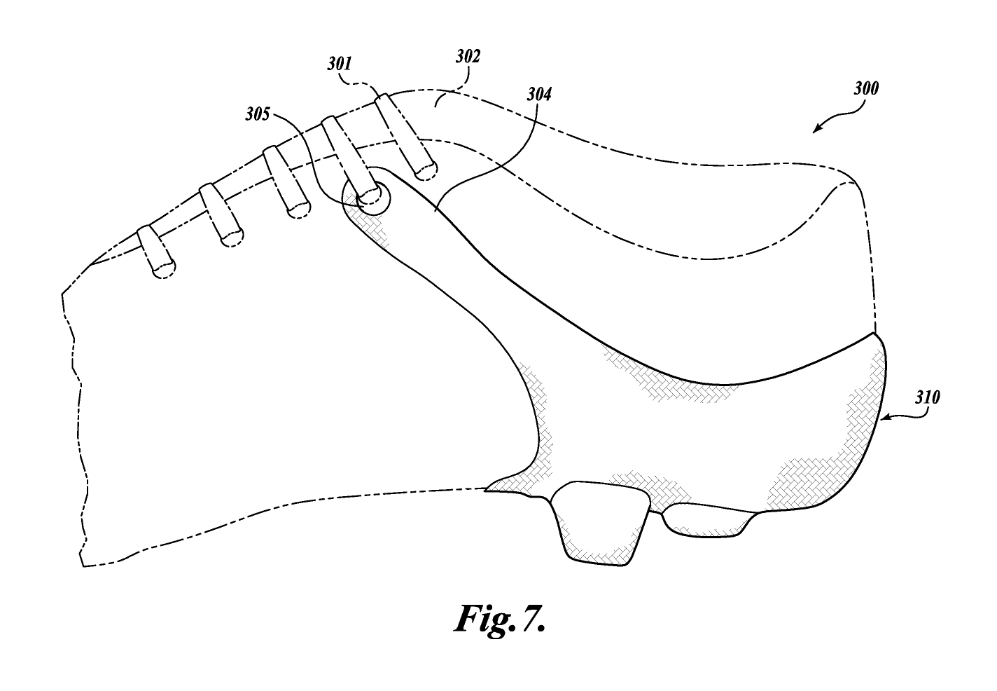

FIG. 7 illustrates a side view of another embodiment of a sports shoe 300 having a heel cup 310 very similar to the heel cup 210 described above, and permanently affixed to a soft upper 302. In this embodiment, the heel cup 310 includes oppositely disposed arms 304 (one visible) that extend upwardly towards the lace or other fastening mechanism 301 for the shoe 300. The arms 304 each include an aperture or eyelet 305 that is positioned to engage the shoe-fastening mechanism 301. Although in this embodiment a single arm 304 extends up each side of the shoe 300, it is contemplated that two or more arms may alternatively be provided on either side of the shoe 300.

In this embodiment, the double thin shell construction disclosed above with a thermoplastic center layer and rigid thin shell outer layers is also provided. In particular, in the preferred embodiment, the thermoplastic center layer extends up through the arms 304, such that the arms 304 are also moldable, to provide a customizable fit and improved support to the user's foot.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for making a user-moldable sports product assembly, comprising:
pre-forming a thermoplastic center member to a desired shape, the center member having an inner surface and an outer surface, wherein the thermoplastic center member is semirigid at temperatures below 110° F. and is moldable at a temperature between 150° F. and 210° F.;
forming a first shell layer from a composite structural material;
placing the center member inner surface over the first shell layer;
forming a second shell layer from the composite structural material onto the center member outer surface; and
curing the user-moldable sports product assembly such that the first shell layer and the second shell layer rigidify to comprise curved thin shell structures.

2. The method of claim 1, wherein the first shell layer and the second shell layer enclose the center member.

3. The method of claim 1, wherein the composite structural material comprises a carbon-fiber-reinforced polymer.

4. The method of claim 1, wherein the thermoplastic material comprises a copolymer mixture with ethylene vinyl acetate.

5. The method of claim 1, wherein the user-moldable sports product assembly comprises a shin guard.

6. The method of claim 3, wherein the shin guard further comprises a supple inner layer fixed to the first shell layer.

7. The method of claim 3, wherein the center member is pre-molded to a shape approximately corresponding to a portion of a user's shin.

8. The method of claim 1, wherein the user-moldable sports product assembly comprises a sports shoe having an upper, a sole, and a heel cup, wherein the pre-formed center member, and first and second shell layers comprise the heel cup.

9. The method of claim 8, wherein the heel cup is permanently attached to the sports shoe.

10. The method of claim 8, wherein the first shell layer is formed directly onto the upper.

11. The method of claim 10, wherein the upper is disposed on a last when the first shell layer is formed onto the upper.

12. The method of claim 8, wherein the sports shoe includes a fastening structure and the heel cup includes oppositely disposed arms that extend upwardly along the upper to directly engage the fastening mechanism.

13. The method of claim 12, wherein the fastening mechanism is a lace.

14. A user-moldable conformable sports product comprising:
a top thin shell structural component comprising a curved thin substantially rigid structure having an initial shape that approximates a desired end shape;
a thermoplastic center layer formed from a material having a moldable transition temperature between 150° F. and 210° F.; and
a bottom thin shell structural component comprising a curved thin shell formed from a curved thin substantially rigid structure having an initial shape that approximates the desired end shape;
wherein when the sports product is heated above the moldable transition temperature the sports component is conformable to the desired end shape, and will rigidly retain the desired end shape when cooled to a temperature below the moldable transition temperature.

15. The user-moldable conformable sports product of claim 14, wherein the sports product comprises a shin guard.

16. The user-moldable conformable sports product of claim 14, wherein the sports product comprises a sports shoe, and further comprises an upper that is permanently fixed to the top thin shell structural component.

17. The user-moldable sports product of claim 16, wherein the top thin shell structural component, thermoplastic center layer, and bottom thin shell structural component comprise a heel cup.

18. The user-moldable sports product of claim 17, wherein the sports shoe further comprises a closure component, and further wherein the heel cup further comprises oppositely disposed arms that extend along the upper to directly engage the closure component.
